(19) United States
(12) Patent Application Publication
(10) Pub. No.: US 2012/0071027 A1
(43) Pub. Date: Mar. 22, 2012

(54) ELECTRICAL CONNECTOR

(75) Inventor: Sheng-Nan Yu, Taipei (TW)

(73) Assignee: CHENG UEI PRECISION INDUSTRY CO., LTD., Taipei (TW)

(21) Appl. No.: 12/887,209

(22) Filed: Sep. 21, 2010

(51) Int. Cl. H01R 13/648

(52) U.S. Cl. 439/607.4

(57) ABSTRACT

An electrical connector is mounted to a printed circuit board which defines a plurality of fastening holes. The electrical connector includes an insulating housing, a plurality of terminals disposed in the insulating housing, and a shielding shell enclosing the insulating housing. Two outer sides of the insulating housing respectively extend outward and then extend forward to form a fastening arm. A narrow slot is formed between the fastening arm and a corresponding side of the insulating housing. The shielding shell has two side plates each of which extends outward and then inclines upward to form a first soldering arm inserted into the fastening hole. A receiving space is formed between each side plate and the corresponding first soldering arm. The fastening arms are snapped into the receiving spaces and rears of the side plates are clipped in the corresponding narrow slots.

### BACKGROUND OF THE INVENTION

1. Field of the Invention

The present invention generally relates to an electrical connector, and more particularly to an electrical connector which has a shielding shell capable of being mounted to a printed circuit board.

2. The Related Art

With the development of electronic products, connections between variety electronic products and peripheral products thereof are more and more frequent. The electronic product and the peripheral product thereof are usually connected by a USB connector. So, using frequencies of the USB connector are increased. The USB connector is widely used in the electronic area, the quality of the USB connector is required better and better. In order to make customers satisfy with the quality, every manufacturer improves the quality of the USB connector through many aspects to make it firmly connect with a mated connector.

A conventional USB connector includes an insulating housing, a plurality of terminals received in the insulating housing and a shielding shell enclosing the insulating housing. The shielding shell is stamped from a metal plate. The shielding shell has a base plate. Several portions of two sides of the base plate respectively extend outward, and then extend upward to form a plurality of soldering feet. The soldering feet are soldered on a printed circuit board through the copper foils.

However, when an external force is exerted on the USB connector, the soldering feet are apt to be deformed. The soldering feet become loosen and a bad electrical connection between the USB connector and the printed circuit board is caused. Therefore, working life of the USB connector is limited accordingly. The phenomenon described above will affect normal work of the USB connector.

### SUMMARY OF THE INVENTION

An object of the present invention is to provide an electrical connector for being mounted to a printed circuit board. The printed circuit board has a containing gap opened at one side thereof and defines a plurality of fastening holes arranged around the containing gap. The electrical connector is received in the containing gap. The electrical connector includes an insulating housing, a plurality of terminals and a shielding shell. The insulating housing has a base portion with two outer sides thereof respectively extending outward and then extending forward beyond the base portion to form a fastening arm. A narrow slot is formed between the fastening arm and a corresponding side of the insulating housing. The terminals are disposed in the insulating housing. The shielding shell encloses the insulating housing, and has two opposite side plates. A bottom portion of each side plate extends outward and then inclines upward to form a first soldering arm inserted into the corresponding fastening hole and then soldered together with the printed circuit board. A receiving space is formed between each of the side plates and the first soldering arm adjacent to the corresponding side plate. The fastening arms are snapped into the receiving space and abut against the respective side plates and insides of the first soldering arms with rears of the side plates being clipped in the corresponding narrow slots.

As described above, when the electrical connector is assembled, the fastening arms are snapped into the receiving space and abut against the respective side plates, and insides of the first and second soldering arms so as to make the top plates engaged with each other firmly to prevent the top plates from separating from each other and decrease deformation extent of the first and second soldering arms under external force. Furthermore, the first and second soldering arms are inserted into the fastening holes and then soldered together with the printed circuit board to make the electrical connector mounted to the printed circuit board steadily and firmly.

### BRIEF DESCRIPTION OF THE DRAWINGS

The present invention will be apparent to those skilled in the art by reading the following description, with reference to the attached drawings, in which:

FIG. 1 is a perspective view of an electrical connector mounted to a printed circuit board according to the present invention;

FIG. 2 is a perspective view of the electrical connector of FIG. 1;

FIG. 3 is an exploded perspective view of the electrical connector of FIG. 1;

FIG. 4 is another angle exploded perspective view of the electrical connector of FIG. 1;

FIG. 5 is a perspective view of a shielding shell of the electrical connector of FIG. 1;

FIG. 6 is an enlarged perspective view of section “A” of the electrical connector shown in FIG. 5; and

FIG. 7 is another angle perspective view of an insulating housing of the electrical connector shown in FIG. 3.

### DETAILED DESCRIPTION OF THE EMBODIMENT

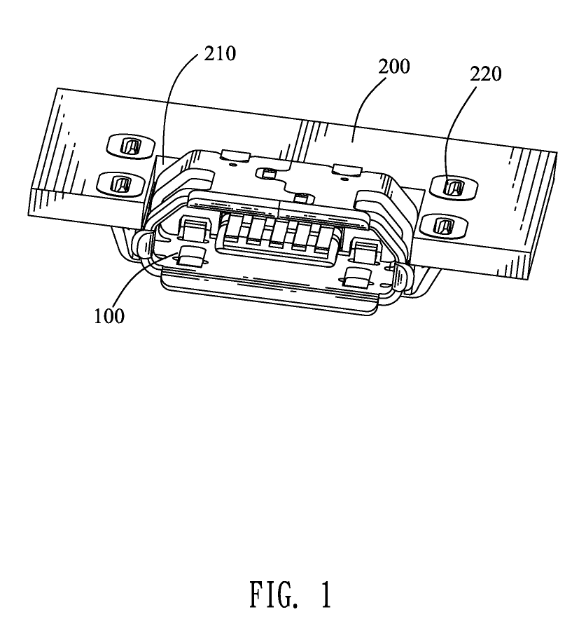

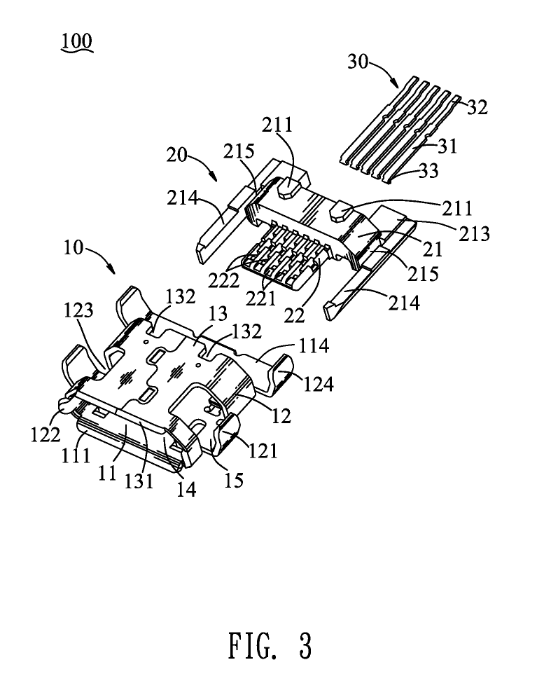

Referring to FIG. 1 and FIG. 3, an electrical connector 100 in accordance with the present invention is mounted to a printed circuit board 200, the electrical connector 100 includes a shielding shell 10, an insulating housing 20 engaged with the shielding shell 10 and a plurality of terminals 30 disposed in the insulating housing 20.

Referring to FIG. 1-FIG. 6, the shielding shell 10 has a base plate 11. Two opposite sides of the base plate 11 extend upward and then are inclined toward each other to form two side plates 12 facing each other. A rear end of the base plate 11 is extended rearward to form a rear plate 114. Top ends of the side plates 12 horizontally extend toward each other to form a pair of top plates 13 engaged with each other. The base plate 11, the two side plates 12 and the pair of top plates 13 are interconnected to form a hollow shape with an inserting space 14 formed thereamong. Two opposite fixing openings 123 are defined in the corresponding side plates 12, and communicate with the inserting space 14. A front end of the base plate 11 extends forward and then is inclined downward to form a first guiding portion 111. Several portions of the base plate 11 are cut off to form a plurality of through-holes 112 thereon. A rear end of each of the through-holes 112 extends towards an opposite end thereof and inclines downward to form a preventing arm 113 freely stretched into the inserting space 14. Two bottom ends of the two fixing openings 123 extend outward and then incline upward to form two first soldering arms 121, respectively. Two side edges of the rear plate 114 extend outward and then are bent upward to form two second soldering arms 124, respectively. Each of the first soldering arms 121 includes a first soldering base 121a extending horizontally, a first slanting portion 121b inclined upward from a free end of the first soldering base 121a, and an first inserting portion 121c extending upward from a free end of the first slanting portion 121b. Each of the second soldering arms 124 includes a second base 124a, a second slanting portion 124b and a second inserting portion 124c. A receiving space 15 is formed between each of the side plates 12 and the first and second soldering arms 121,124 adjacent to the corresponding side plate 12. The receiving space 15 extends along a front-to-rear direction. A front end edge of each side plate 12 extends forward and is inclined upward to form a second guiding portion 122. Front ends of the top plates 13 extend forward and are inclined upward to form a third guiding portion 131. A rear end of each of the top plates 13 concaves inward to form a buckling groove 132.

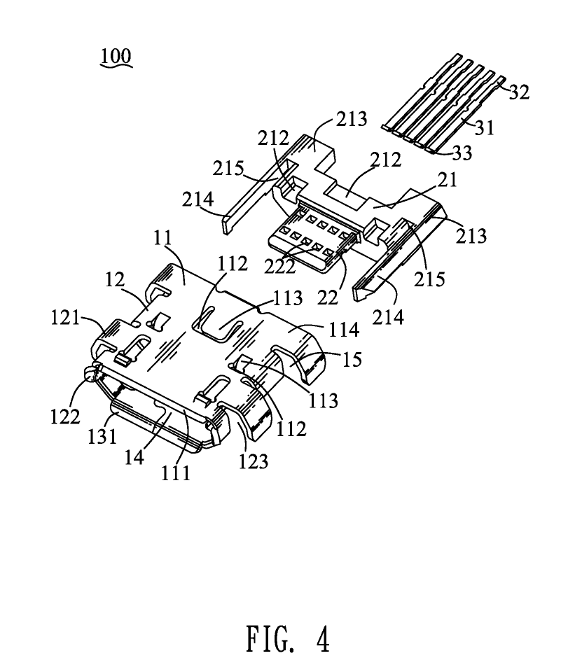

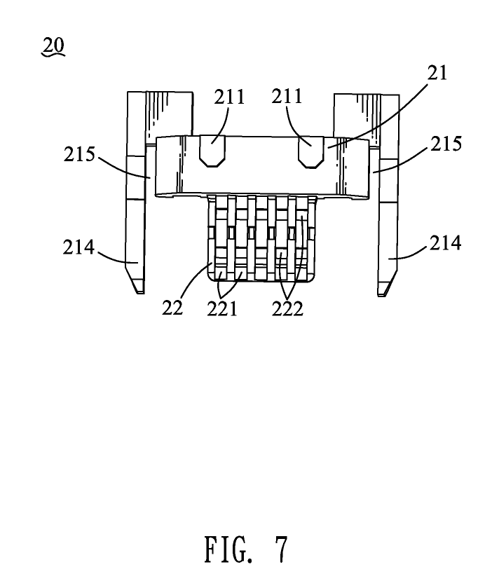

Referring to FIG. 3, FIG. 4 and FIG. 7, the insulating housing 20 has a base portion 21 engaged in a rear of the inserting space 14 of the shielding shell 10 and a tongue portion 22 extended forward from a middle of a front of the base portion 21. A top of the tongue portion 22 defines a plurality of terminal cavities 221 extending rearward to pass through the base portion 21. A bottom of each of the terminal cavities 221 defines two rectangular holes 222 located at a front and a rear thereof, respectively. Two portions of a top of the base portion 21 protrude upward to form two blocks 211. Several portions of a bottom of the base portion 21 concave inward to form a plurality of locking recesses 212. Two rear corners of the base portion 21 respectively extend rearward to form a connecting block 213. An outer side of each of the connecting block 213 extends outward, and then extends forward beyond the base portion 21 to form a fastening arm 214. A narrow slot 215 is formed between the fastening arm 214 and a corresponding side of the base portion 21.

Referring to FIGS. 3-4, the terminal 30 is of an elongated shape and has a contacting portion 31. One end of the contacting portion 31 extends rearward to form a soldering portion 32. The other end of the contacting portion 31 extends forward to form a fixing portion 33.

Referring to FIGS. 1-7, when the electrical connector 100 is assembled, the terminals 30 are received in the terminal cavities 221 of the insulating housing 20 with two portions of the contacting portions 31 being exposed from the holes 222 and the fixing portions 33 being buckled in the terminal cavities 221. The base portion 21 and the tongue portion 22 are inserted into the inserting space 14 of the shielding shell 10. The blocks 211 are buckled in the buckling grooves 132. The fastening portions 213 are located at two sides of the rear board 114. The fastening arms 214 are snapped into the receiving spaces 15 and abut against the respective side plates 12, and insides of the first and second soldering bases 121a, 124a and the first and second slanting portions 121b, 124b so as to make the top plates 13 engaged with each other firmly to prevent the top plates 13 from separating from each other. Meanwhile, rears of the side plates 12 are clipped in the corresponding narrow slots 215. Front ends of the preventing arms 113 are snapped into the corresponding locking recesses 212 for making the insulating housing 20 located in the shielding shell 10 firmly.

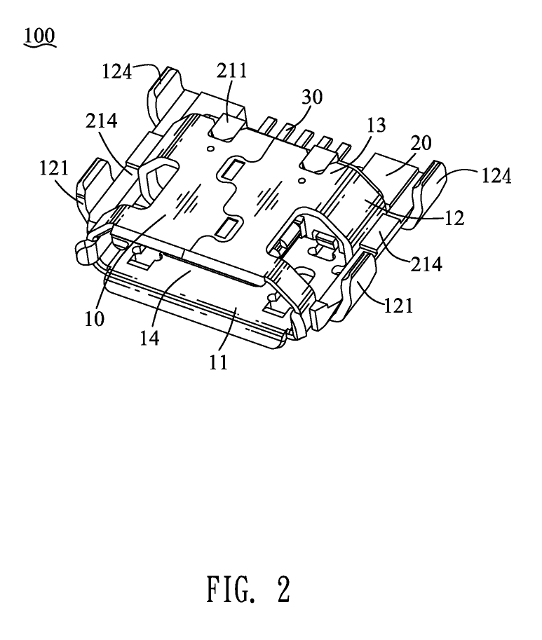

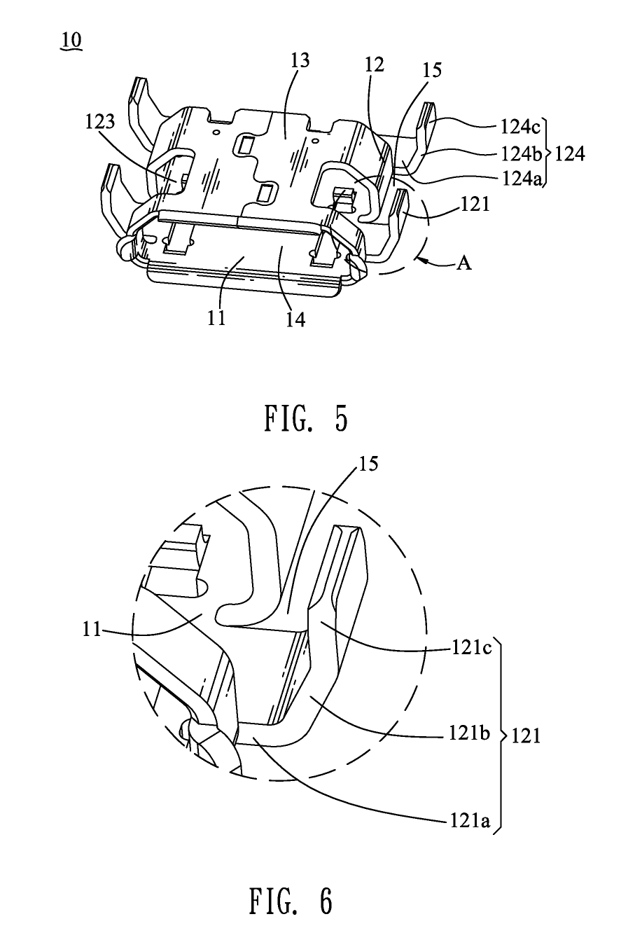

Referring to FIG. 1, FIG. 2, FIG. 3, FIG. 5 and FIG. 6, the electrical connector 100 is mounted to the printed circuit board 200. The printed circuit board 200 has a containing gap 210 opened at one side thereof. The printed circuit board 200 defines a plurality of fastening holes 220 arranged around the containing gap 210. Firstly, the electrical connector 100 is received in the containing gap 210 with the first and second inserting portions 121c, 124c of the first and second soldering arms 121, 124 being inserted into the fastening holes 220 of the printed circuit board 200. Then, the first and second inserting portions 121c, 124c are soldered together with the fastening holes 220 of the printed circuit board 200. A mated connector can be inserted into the inserting space 14 of the shielding shell 30 through the first guiding portion 111, the second guiding portions 122 and the third guiding portion 131 to reach an electrical connection between the mated connector and the electrical connector 100.

As described above, when the electrical connector 100 is assembled, the fastening arms 214 are snapped into the receiving space 15 and abut against the respective side plates 12, and insides of the first and second soldering bases 121a, 124a and the first and second slanting portions 121b, 124b so as to make the top plates 13 engaged with each other firmly to prevent the top plates 13 from separating from each other and decrease deformation extent of the first and second soldering arms 121, 124 under external force. Furthermore, the first and second inserting portions 121c, 124c of the first and second soldering arms 121, 124 are inserted into the fastening holes 220 and then soldered together with the printed circuit board 200 to make the electrical connector 100 mounted to the printed circuit board 200 steadily and firmly.

What is claimed is:

1. An electrical connector for being mounted to a printed circuit board, the printed circuit board having a containing gap opened at one side thereof and defining a plurality of fastening holes arranged around the containing gap, the electrical connector being received in the containing gap, comprising:
an insulating housing, the insulating housing having a base portion with two outer sides of rear ends thereof respectively extending outward and then extending forward beyond the base portion to form a fastening arm, a narrow slot being formed between the fastening arm and a corresponding side of the insulating housing;
a plurality of terminals disposed in the insulating housing; and
a shielding shell enclosing the insulating housing, and having two opposite side plates, a bottom portion of each side plate extending outward and then inclining upward to form a first soldering arm inserted into the corresponding fastening hole and then soldered together with the printed circuit board, a receiving space being formed between each of the side plates and the first soldering arm adjacent to the corresponding side plate, the fastening arms being snapped into the receiving spaces and abutting against the respective side plates and insides of the first soldering arms with rears of the side plates being clipped in the corresponding narrow slots.

2. The electrical connector as claimed in claim 1, wherein each of the first soldering arms includes a first soldering base extending horizontally, a first slanting portion inclined upward from a free end of the soldering base and an first inserting portion extending upward from a free end of the first slanting portion, the fastening arms abut against insides of the first soldering bases and the first slanting portions, and the first inserting portion of the first soldering arms are inserted into the fastening holes.

3. The electrical connector as claimed in claim 1, wherein two rear corners of the base portion respectively extend outward and then rearward to form a connecting block, an outer side of each of the connecting blocks extends outward, and then extends forward to form the fastening arm.

4. The electrical connector as claimed in claim 3, wherein the shielding shell has a base plate, a rear end of the base plate is extended rearward to form a rear plate, two side edges of the rear plate extend outward and then are bent upward to form two second soldering arms, the connecting blocks are located at two sides of the rear plate, the second soldering arms are inserted and soldered to the corresponding fastening holes of the printed circuit board and restrict rear ends of the fastening arms.

5. The electrical connector as claimed in claim 1, wherein two opposite fixing openings are defined in the corresponding side plates, respectively, bottom ends of the two fixing openings extend outward and then are bent upward to form the first soldering arms.

6. The electrical connector as claimed in claim 1, wherein the shielding shell is of a hollow shape with an inserting space formed for accommodating the base portion of the insulating housing and a tongue portion extended from.
